(19) United States
(12) Patent Application Publication
(10) Pub. No.: US 2026/0291827 A1
(43) Pub. Date: Sep. 24, 2026

(54) METHOD AND APPARATUS OF MODEL MONITORING FOR ARTIFICIAL INTELLIGENCE (AI)-BASED CHANNEL STATE INFORMATION (CSI) PREDICTION

(71) Applicant: MEDIATEK INC., Hsinchu City (TW)

(72) Inventors: Yu-Ching HUANG, Hsinchu City (TW); Gyu Bum KYUNG, San Jose, CA (US)

(73) Assignee: MEDIATEK INC., Hsinchu City (TW)

(21) Appl. No.: 19/472,770

(22) PCT Filed: Jun. 26, 2024
(86) PCT No.: PCT/CN2024/101555

§ 371 Date: Oct. 6, 2025

Related U.S. Application Data
(60) Provisional application No. 63/511,693, filed on Jul. 3, 2023.

(51) Int. Cl. H04L 41/16; H04B 7/06; H04W 72/0446

(52) U.S. Cl. CPC H04L 41/16; H04B 7/0626; H04W 72/0446

(57) ABSTRACT

In an aspect of the disclosure, a method, a computer-readable medium, and an apparatus are provided. The method may be performed by a UE. In certain configurations, the UE receives, from a base station, a signal to activate a model monitoring process for artificial intelligence (AI)/machine learning (ML)-based channel state information (CSI) prediction with a current model. The UE performs the AI/ML-based CSI prediction. In response to determining that an adjustment to the current model is required, the UE implements the adjustment to the current model. In certain configurations, calculation of performance metrics of the current model and monitoring of the current model may be performed at the UE or the base station.

### CROSS-REFERENCE TO RELATED APPLICATION(S)

This application claims the benefits of U.S. Provisional Application Ser. No. 63/511,693, entitled “Method and Apparatus of Model Monitoring for Artificial Intelligence (AI)-based Channel State Information (CSI) Prediction” and filed on Jul. 3, 2023. The disclosure of the above-identified application is expressly incorporated by reference herein in their entirety.

### TECHNICAL FIELD

The present disclosure relates generally to communication systems, and more particularly, to techniques of methods and apparatuses of model monitoring for artificial intelligence (AI)-based channel state information (CSI) prediction.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE receives, from a base station, a signal to activate a model monitoring process for artificial intelligence (AI)/machine learning (ML)-based channel state information (CSI) prediction with a current model. The UE performs the AI/ML-based CSI prediction. In response to determining that an adjustment to the current model is required, the UE implements the adjustment to the current model.

In another aspect of the disclosure, a method, a computer-readable medium, and an apparatus are provided. The method may be performed by a base station. In certain configurations, the base station transmits, to a UE, a signal to activate a model monitoring process for AI/ML-based CSI prediction with a current model. The UE is configured to perform the AI/ML-based CSI prediction, and to implement an adjustment to the current model in response to determining that the adjustment is required.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example network (NW)-side model monitoring process for AI/ML-based CSI prediction between a UE and a base station.

FIG. 8 is a diagram illustrating another example NW-side model monitoring process for AI/ML-based CSI prediction between a UE and a base station.

FIG. 9 is a diagram illustrating an example UE-side model monitoring process for AI/ML-based CSI prediction between a UE and a base station.

FIG. 10 is a diagram illustrating an example hybrid model monitoring process for AI/ML-based CSI prediction between a UE and a base station.

FIG. 11 is a diagram illustrating performance metrics being calculated based on both predicted and observed CSI-RS symbols when the prediction interval is equal to the observation interval.

FIG. 12 is a diagram illustrating performance metrics being calculated based solely on predicted CSI-RS symbols when the prediction interval is not equal to the observation interval.

FIG. 13 is a flow chart of a method (process) for wireless communication of a UE.

FIG. 14 is a flow chart of a method (process) for wireless communication of a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

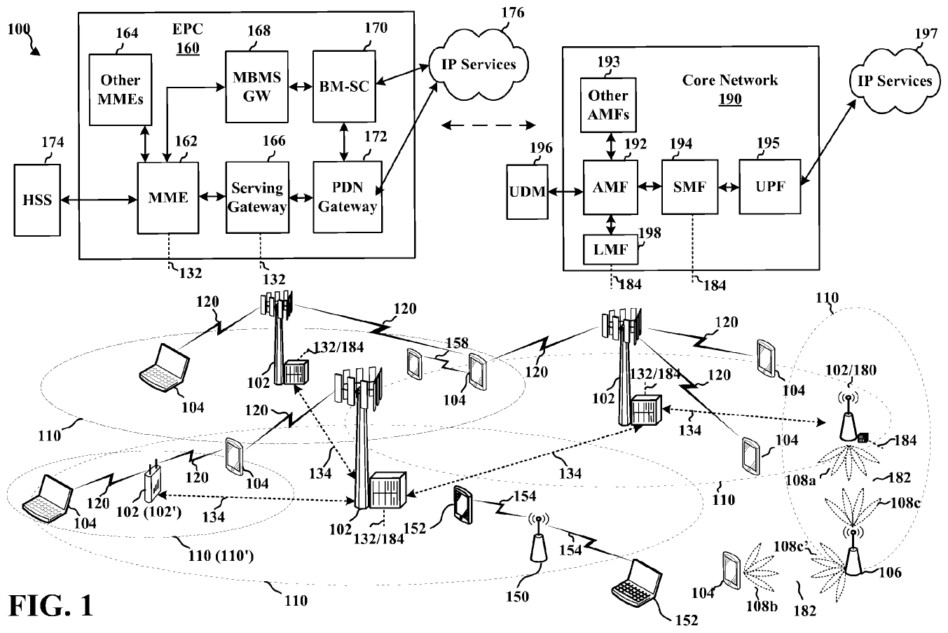

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ 300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

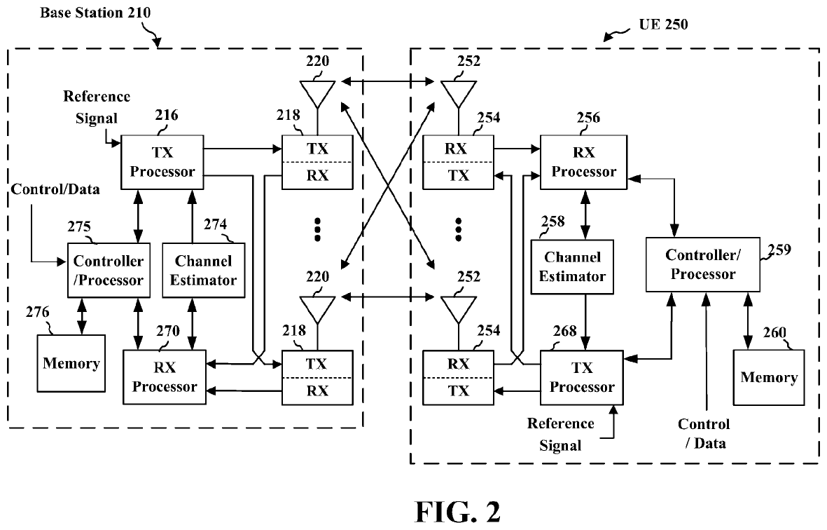

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

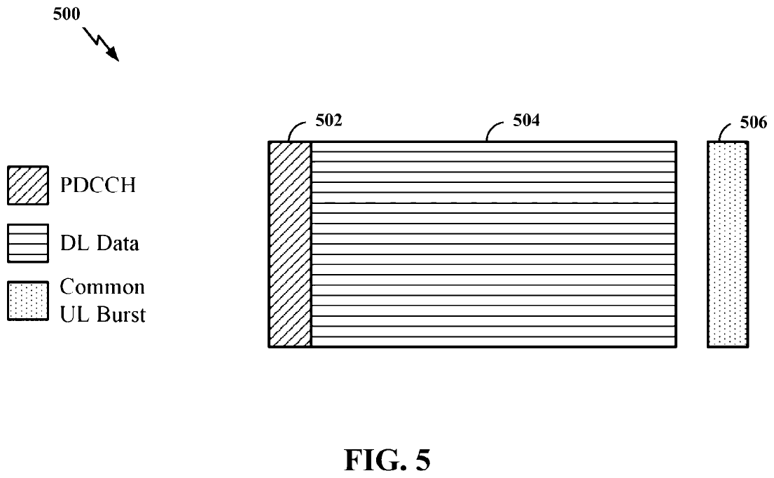

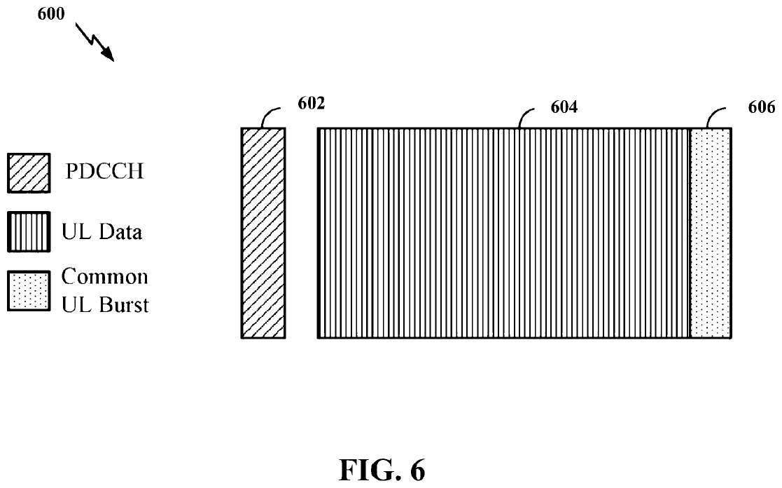

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

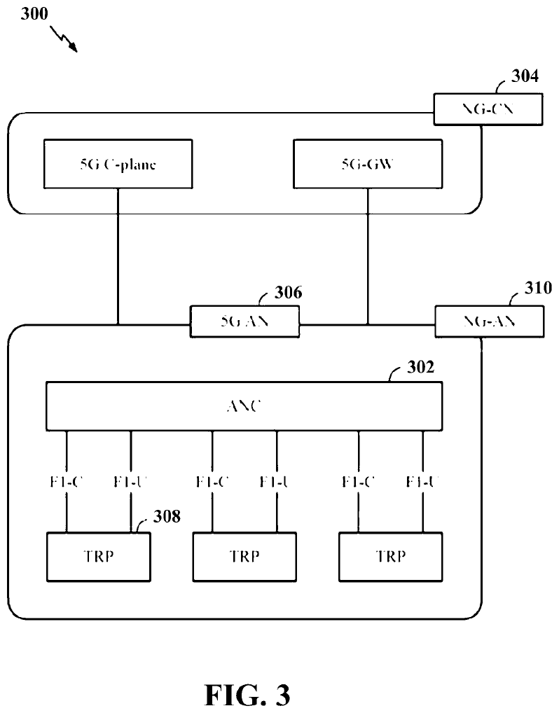

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

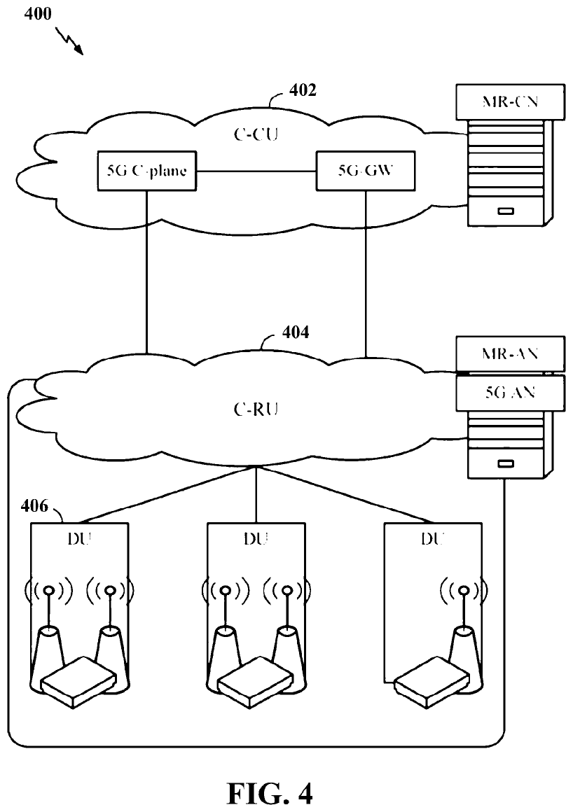

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Channel state information (CSI) prediction is a fundamental problem in wireless communication systems, which involves analyzing the radio environment and evaluating parameters to make decisions for optimal communication. In particular, CSI refers to the channel properties that affect how signals travel from a transmitter to a receiver. For example, in the mobile scenario, outdated CSI can negatively impact adaptive transmission systems and degrade system performance. Therefore, it is important to predict CSI in the future to obtain accurate information.

In certain configurations, getting the accurate CSI report at the proper timing is crucial for physical layer operation of most of wireless system, particularly for the system like 5G/NR which uses high degree of MIMO technology. However, getting the CSI report all the time usually requires very frequent CSI report and the frequent CSI report causes huge overhead. Thus, the motivation for using AI/ML algorithms for CSI prediction is to address the issue of channel aging, which is the delay between when CSI is reported and when it is used by the base station (i.e., gNB). This delay leads to the reported CSI being outdated, particularly at a higher UE speed. AI/ML-based CSI prediction aims to mitigate the effects of outdated CSI by forecasting future CSI states, enabling more accurate and timely adjustments to the wireless network, enhancing overall communication performance.

However, the evaluation shows that AI/ML-based CSI prediction does not generalize well across UE speed. Therefore, it is crucial to monitor the model for detecting outdated AI/ML models that do not match the current environment or scenario. Monitoring AI/ML models is important because it helps detect when a model is no longer accurate or relevant, allowing for updates or replacements to be made.

In certain configurations, aspects of the present disclosure relate to methods and apparatuses of model monitoring for AI/ML-based CSI prediction, allowing calculation of the model monitoring metric and model adjustments at either the NW-side (i.e., base station) or the UE-side.

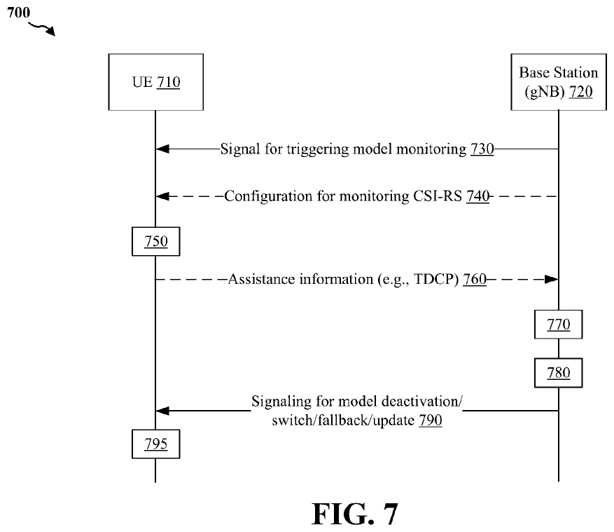

FIG. 7 is a diagram illustrating an example network (NW)-side model monitoring process for AI/ML-based CSI prediction between a UE 710 and a base station 720. Specifically, the model monitoring process 700 is a NW-side model monitoring process, in which the network (i.e., base station 720) performs the calculation of performance metrics of the current model and determines if there is any necessary adjustment (i.e., deactivation, switch, fallback or update) to the current model required.

As shown in FIG. 7, at operation 730, the base station 720 transmits a signal to the UE 710 to trigger/activate a model monitoring process for AI/ML-based CSI prediction with a current model. Optionally, at operation 740, the base station 720 transmits a configuring message with configuration information for configuring CSI reference signal (CSI-RS) symbols for monitoring to the UE 710. In certain embodiments, alternatively, the UE 710 may directly bundle the current CSI-RS symbols for monitoring purposes, and in this case, the configuration in operation 740 is not necessary. Upon receiving the signal at operation 730 (and the optional configuring message at operation 740), at operation 750, the UE 710 performs the AI/ML-based CSI prediction. Optionally, at operation 760, the UE 710 follows the existing framework and provides feedback to the base station 720 by transmitting UE-specific assistance information to the base station 720 for assisting the base station 720 in determining whether the adjustment to the current model is required. In certain embodiments, the assistance information may include time domain channel property (TDCP), which indicates the degree of time-variability of the channel, as being standardized and defined in the Release 18 (Rel-18) multiple input multiple output technology (MIMO).

At the base station 720, at operation 770, the base station 720 performs the calculation of performance metrics of the current model. In certain embodiments, the base station 720 calculates the performance metrics according to system performance information, e.g., Block Error Rate (BLER), Throughput or acknowledgement/negative acknowledgement (ACK/NACK) information. At operation 780, the base station 720 monitors the current model for determining whether the adjustment to the current model is required. Specifically, the adjustment to the current model may be deactivation (i.e., deactivating the current model), switch (i.e., switching from the current model to a new model), fallback (i.e., performing fallback from the current model to a non-AI based model), or update (i.e., updating or fine-tuning the current model). Once the base station 720 determines that an adjustment to the current model is required, at operation 790, the base station 720 transmits a signal to the UE 710 for indicating the adjustment to the current model. At the UE 710, upon receiving the signal at operation 790, at operation 795, the UE 710 implements the adjustment to the current model.

In the model monitoring process 700, the UE 710 is not required to report any content for model monitoring to the base station 720, and the decisions regarding model adjustment (e.g., deactivation/switch/fallback/update) are solely made by the base station 720. However, the base station 720 determines whether the adjustment to the current model (e.g., deactivate/switch/fallback/update) is required only based on the system performance information, and in certain configurations, this approach may lead to inaccurate decisions, as the system performance is not entirely dependent on the AI/ML models alone.

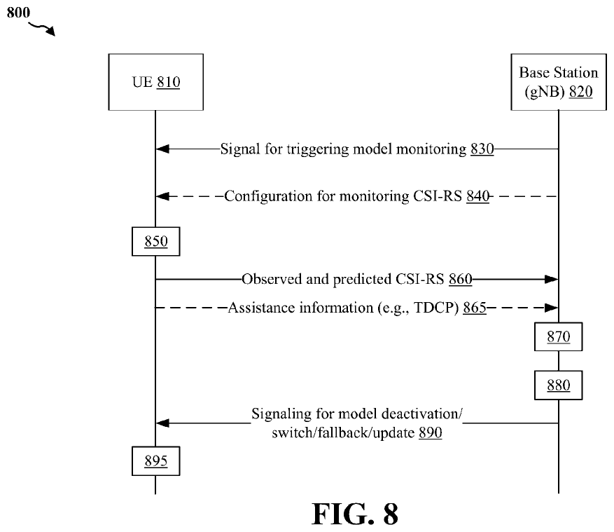

FIG. 8 is a diagram illustrating another example NW-side model monitoring process for AI/ML-based CSI prediction between a UE 810 and a base station 820. Specifically, the model monitoring process 800 is also a NW-side model monitoring process, in which the network (i.e., base station 820) performs the calculation of performance metrics of the current model and determines if there is any necessary adjustment (i.e., deactivation, switch, fallback or update) to the current model required.

As shown in FIG. 8, at operation 830, the base station 820 transmits a signal to the UE 810 to trigger/activate a model monitoring process for AI/ML-based CSI prediction with a current model. Optionally, at operation 840, the base station 820 transmits a configuring message with configuration information for configuring CSI-RS symbols for monitoring to the UE 810. In certain embodiments, alternatively, the UE 810 may directly bundle the current CSI-RS symbols for monitoring purposes, and in this case, the configuration in operation 840 is not necessary. Upon receiving the signal at operation 830 (and the optional configuring message at operation 840), at operation 850, the UE 810 performs the AI/ML-based CSI prediction. Once the prediction is complete, at operation 860, the UE 810 transmits a feedback message to the base station 820 with the observed CSI-RS and the predicted CSI-RS. Optionally, at operation 865, the UE 810 follows the existing framework and provides feedback to the base station 820 by transmitting assistance information to the base station 820 for assisting the base station 820 in determining whether the adjustment to the current model is required. In certain embodiments, the assistance information may include TDCP. However, the optional operation 865 may be unnecessary as the UE 810 transmits the feedback of the observed CSI-RS and the predicted CSI-RS to the base station 820.

At the base station 820, at operation 870, the base station 820 performs the calculation of performance metrics of the current model. In certain embodiments, the base station 820 calculates the performance metrics according to intermediate Key Performance Indicators (KPIs), such as normalized mean square error (NMSE) or squared generalized cosine similarity (SGCS). At operation 880, the base station 820 monitors the current model for determining whether the adjustment to the current model is required. Specifically, the adjustment to the current model may be deactivation (i.e., deactivating the current model), switch (i.e., switching from the current model to a new model), fallback (i.e., performing fallback from the current model to a non-AI based model), or update (i.e., updating or fine-tuning the current model). Once the base station 820 determines that an adjustment to the current model is required, at operation 890, the base station 820 transmits a signal to the UE 810 for indicating the adjustment to the current model. At the UE 810, upon receiving the signal at operation 890, at operation 895, the UE 810 implements the adjustment to the current model.

The model monitoring process 800 is mainly different from the model monitoring process 700 in the operation 860, where the UE 810 transmits the feedback message to the base station 820 with the observed CSI-RS and the predicted CSI-RS. Specifically, in the model monitoring process 800, in order to calculate the performance metrics at the base station 820, the UE 810 provides the feedback message on both observed and predicted CSI-RS to the base station 820. However, this approach may result in a large transmission overhead. In certain configurations, even in a TDD scenario where only predicted CSI-RS needs to be provided, it may still cause significant overhead compared to providing a single value such as NMSE or SGCE.

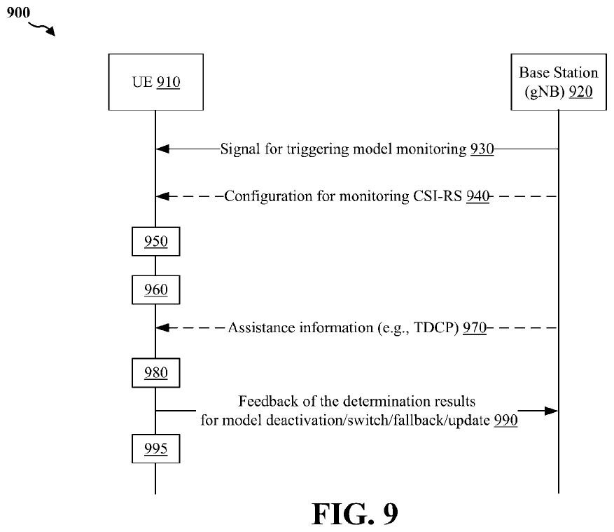

FIG. 9 is a diagram illustrating an example UE-side model monitoring process for AI/ML-based CSI prediction between a UE 910 and a base station 920. Specifically, the model monitoring process 900 is a UE-side model monitoring process, in which the UE 910 performs the calculation of performance metrics of the current model and determines if there is any necessary adjustment (i.e., deactivation, switch, fallback or update) to the current model required. In this case, the UE 910 may implement the adjustment on its own.

As shown in FIG. 9, at operation 930, the base station 920 transmits a signal to the UE 910 to trigger/activate a model monitoring process for AI/ML-based CSI prediction with a current model. Optionally, at operation 940, the base station 920 transmits a configuring message with configuration information for configuring CSI-RS symbols for monitoring to the UE 910. In certain embodiments, alternatively, the UE 910 may directly bundle the current CSI-RS symbols for monitoring purposes, and in this case, the configuration in operation 940 is not necessary. In certain configurations, if the observation interval differs from the prediction interval, the base station 920 may provide additional future CSI-RS to the UE 910. Alternatively, if the observation interval differs from the prediction interval, the UE 910 may subsequently perform the metric calculation by considering only the CSI-RS with the same interval, which will be described in details later.

Upon receiving the signal at operation 930 (and the optional configuring message at operation 940), at operation 950, the UE 910 performs the AI/ML-based CSI prediction. Once the prediction is complete, at operation 960, the UE 910 performs the calculation of performance metrics of the current model. In certain embodiments, the performance metrics being calculated may be either the input/output-based metrics or intermediate KPIs such as NMSE/SGCS. In addition, the criteria for these metrics are pre-defined. Optionally, at operation 965, the base station 920 transmits UE-specific assistance information to the UE 910 for assisting the UE 910 in determining whether the adjustment to the current model is required. In certain embodiments, the assistance information may include, for example, deployment/environment information.

At operation 980, the UE 910 monitors the current model for determining whether the adjustment to the current model is required. Specifically, the adjustment to the current model may be deactivation (i.e., deactivating the current model), switch (i.e., switching from the current model to a new model), fallback (i.e., performing fallback from the current model to a non-AI based model), or update (i.e., updating or fine-tuning the current model). Once the UE 910 determines that an adjustment to the current model is required, at operation 990, the UE 910 transmits determination feedback of the adjustment to the current model to the base station 920, such that the base station 920 is aware of the final decision of the monitoring. At operation 995, the UE 910 implements the adjustment to the current model.

The model monitoring process 900 is different from the model monitoring process 700 and the model monitoring process 800 in that the metric calculation and the model monitoring operations are performed by the UE 910. However, in the model monitoring process 900, the challenge exists in that it may be difficult for a single UE 910 to perceive where it is located and the corresponding scenario, since the monitoring data collected by the UE 910 is limited. Further, it may be difficult for the base station to provide the UE-specific assistance information to the UE 910 if the base station 920 is serving too many UEs at the same time.

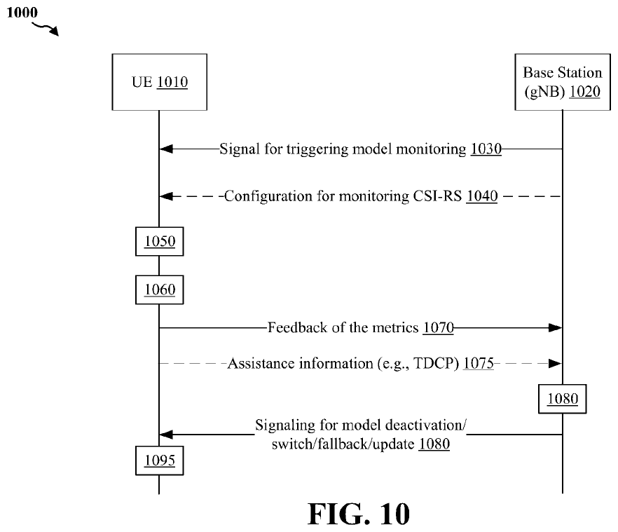

FIG. 10 is a diagram illustrating an example hybrid model monitoring process for AI/ML-based CSI prediction between a UE and a base station. Specifically, the model monitoring process 1000 is a hybrid model monitoring process, in which the UE 1010 performs the calculation of performance metrics of the current model and provides the feedback of the calculation to the base station 1020, and the base station 1020 then determines if there is any necessary adjustment (i.e., deactivation, switch, fallback or update) to the current model required.

As shown in FIG. 10, at operation 1030, the base station 1020 transmits a signal to the UE 1010 to trigger/activate a model monitoring process for AI/ML-based CSI prediction with a current model. Optionally, at operation 1040, the base station 1020 transmits a configuring message with configuration information for configuring CSI-RS symbols for monitoring to the UE 1010. In certain embodiments, alternatively, the UE 1010 may directly bundle the current CSI-RS symbols for monitoring purposes, and in this case, the configuration in operation 940 is not necessary. In certain configurations, if the observation interval differs from the prediction interval, the base station 1020 may provide additional future CSI-RS to the UE 1010, e.g., by downlink control information (DCI). Alternatively, if the observation interval differs from the prediction interval, the UE 1010 may subsequently perform the metric calculation by considering only the CSI-RS with the same interval, which will be described in details later.

Upon receiving the signal at operation 1030 (and the optional configuring message at operation 1040), at operation 1050, the UE 1010 performs the AI/ML-based CSI prediction. Once the prediction is complete, at operation 1060, the UE 1010 performs the calculation of performance metrics of the current model. In certain embodiments, the performance metrics being calculated may be either the input/output-based metrics or intermediate KPIs such as NMSE/SGCS. In addition, the criteria for these metrics are pre-defined. At operation 1070, the UE 1010 transmits a feedback message of the performance metrics obtained by the calculation to the base station 1020. Optionally, at operation 1075, the UE 1010 may provide additional UE-specific assistance information to the base station 1020 for assisting the base station 1020 in determining whether the adjustment to the current model is required. In certain embodiments, for example, the UE 1010 may self-detect its moving speed and provide this information as the assistance information to the base station 1020, or it can provide TDCP information as the assistance information to the base station 1020.

At the base station 1020, based on the feedback message received at operation 1070 (and the optional UE-specific assistance information at operation 1075), at operation 1080, the base station 1020 monitors the current model for determining whether the adjustment to the current model is required. Specifically, the adjustment to the current model may be deactivation (i.e., deactivating the current model), switch (i.e., switching from the current model to a new model), fallback (i.e., performing fallback from the current model to a non-AI based model), or update (i.e., updating or fine-tuning the current model). Once the base station 1020 determines that an adjustment to the current model is required, at operation 1090, the base station 1020 transmits a signal to the UE 1010 for indicating the adjustment to the current model. At the UE 1010, upon receiving the signal at operation 1090, at operation 1095, the UE 1010 implements the adjustment to the current model.

In the model monitoring process 1000, the UE 1010 performs the calculation of performance metrics of the current model and provides the feedback of the calculation to the base station 1020, and the base station 1020 then determines if an adjustment (i.e., deactivation, switch, fallback or update) to the current model is required. In this approach, a challenge exists in that the base station 1020 needs to have prior knowledge of the corresponding supported model/functionality IDs for different UEs.

In the model monitoring processes 700, 800, 900 and 1000, the base station transmits the signal to the UE to trigger/activate a model monitoring process, and the UE, upon receiving the signal, performs the AI/ML-based CSI prediction. The subsequent metrics calculation and model monitoring operations may be done by either the UE or the base station. In the NW-side model monitoring processes 700 or 800 or the hybrid model monitoring process 1000, the UE may transmit UE-specific assistance information such as TDCP to the base station to assist the model monitoring process. In the UE-side model monitoring process 900, the base station may transmit UE-specific assistance information, such as environment data, to the UE to aid in the model monitoring process. In the NW-side model monitoring process 700, the model monitoring operation may be performed by depending on the system performance indicators such as BLER, throughput, and ACK/NACK information. In the UE-side model monitoring process 900 and the hybrid model monitoring process 1000, the model monitoring operation may be performed by depending on the input/output-based metric or intermediate KPIs.

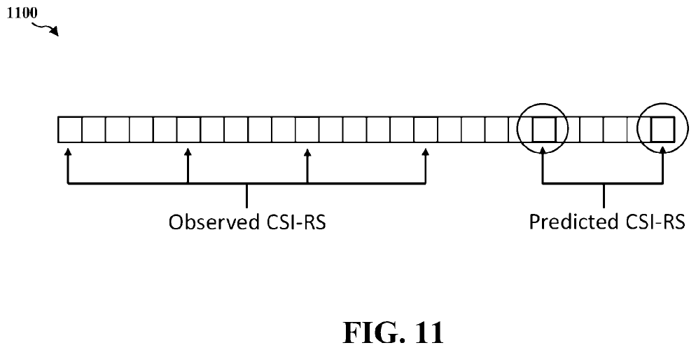

FIG. 11 is a diagram illustrating performance metrics being calculated based on both predicted and observed CSI-RS symbols when the prediction interval is equal to the observation interval. Specifically, when a UE (e.g., UE 710, 810, 910 or 1010) receives configuration information for configuring CSI-RS symbols for monitoring from the base station, the configuration may indicate that the prediction interval is equal to the observation interval of the CSI-RS symbols. In this case, the performance metrics are calculated based on the predicted CSI-RS and ground truth CSI-RS. As shown in FIG. 11, the ground truth CSI-RS may be obtained in the next few cycles during the periodic CSI-RS configuration. In other words, calculation of the performance metrics of the current model may be performed based on observed CSI-RS symbols and predicted CSI-RS symbols obtained in the AI/ML-based CSI prediction when the prediction interval is equal to the observation interval.

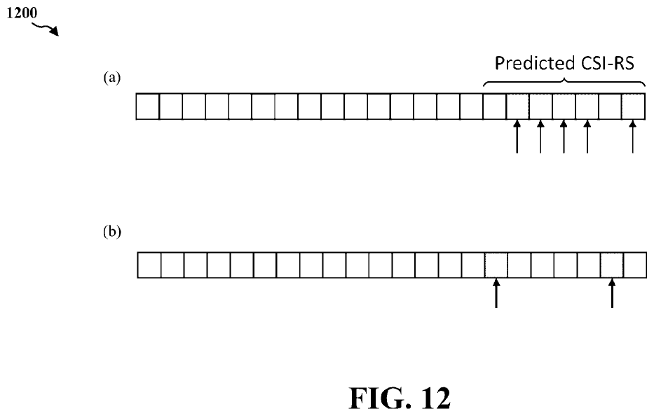

FIG. 12 is a diagram illustrating performance metrics being calculated based solely on predicted CSI-RS symbols when the prediction interval is not equal to the observation interval. Specifically, when a UE (e.g., UE 710, 810, 910 or 1010) receives configuration information for configuring CSI-RS symbols for monitoring from the base station, it is also possible that the configuration may indicate that the prediction interval is not equal to the observation interval of the CSI-RS symbols. Thus, as shown in FIG. 12(a), the UE is unable to acquire the ground truth CSI-RS, as these CSI-RS occasions are not configured during the specified CSI-RS periodicity. In addition, the additional future CSI-RS need to be configured for calculating the performance metric, which results in an increase of the transmission overhead. Accordingly, when the prediction interval is not equal to the observation interval of the CSI-RS symbols, calculation of the performance metrics of the current model is performed based solely on the predicted CSI-RS symbols, which has identical intervals as the CSI-RS periodicity, as shown in FIG. 12(b). In other words, the calculation of the performance metrics is performed based on the predicted CSI-RS that has the same intervals as the CSI-RS periodicity.

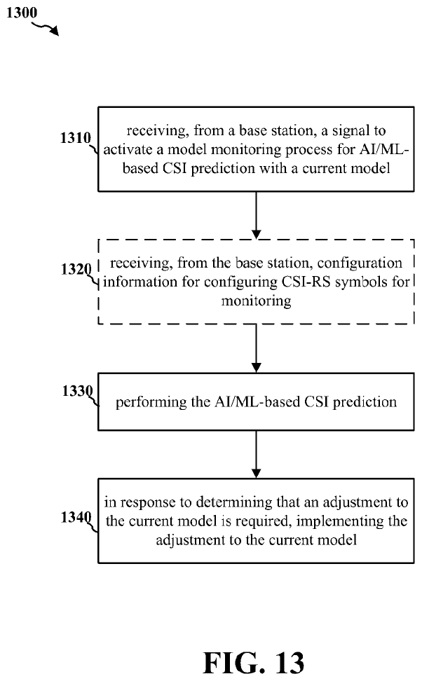

FIG. 13 is a flow chart of a method (process) for wireless communication of a UE. The method may be performed by a UE (e.g., UE 710, 810, 910 or 1100). At procedure 1310, the UE receives, from a base station, a signal to activate a model monitoring process for AI/ML-based CSI prediction with a current model. Optionally, at procedure 1320, the UE receives, from the base station, configuration information for configuring CSI-RS symbols for monitoring. At procedure 1330, the UE performs the AI/ML-based CSI prediction. In certain configurations, calculation of performance metrics of the current model and monitoring of the current model may be subsequently performed at the UE or at the base station. At procedure 1340, in response to determining that an adjustment to the current model is required, the UE implements the adjustment to the current model.

In certain embodiments, in a NW-side model monitoring process, the base station is configured to perform calculation of performance metrics of the current model, and to monitor the current model for determining whether the adjustment to the current model is required. Once the base station determines that the adjustment to the current model is required, the UE then receives, from the base station, a signal indicating the adjustment to the current model. In one embodiment, the UE transmits, to the base station, UE-specific assistance information including TDCP for assisting the base station in determining whether the adjustment to the current model is required. In another embodiment, the UE transmits, to the base station, observed CSI reference signal (CSI-RS) and predicted CSI-RS, and the base station is configured to perform calculation of the performance metrics of the current model based on the observed CSI-RS and the predicted CSI-RS.

In certain embodiments, in a UE-side model monitoring process, the UE performs calculation of performance metrics of the current model. The UE determines whether the adjustment to the current model is required. In response to determining that the adjustment to the current model is required, the UE implements the adjustment to the current model, and transmits determination feedback of the adjustment to the current model to the base station. In one embodiment, the UE receives, from the base station, UE-specific assistance information for assisting the UE in determining whether the adjustment to the current model is required.

In certain embodiments, in a hybrid model monitoring process, the UE performs calculation of performance metrics of the current model. The UE transmits, to the base station, the performance metrics of the current model, wherein the base station is configured to determine whether the adjustment to the current model is required. Once the base station determines that the adjustment to the current model is required, the UE receives, from the base station, a signal indicating the adjustment to the current model. In one embodiment, the UE transmits, to the base station, UE-specific assistance information including TDCP for assisting the base station in determining whether the adjustment to the current model is required.

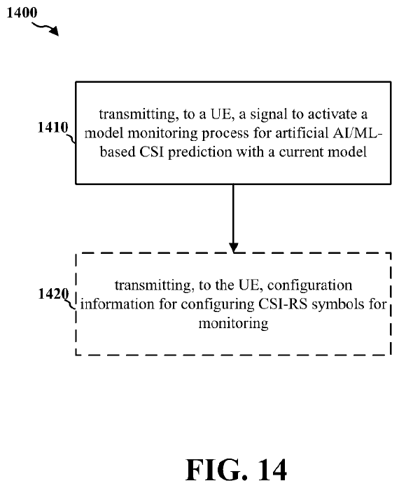

FIG. 14 is a flow chart of a method (process) for wireless communication of a base station. The method may be performed by a base station (e.g., gNB, base station 720, 820, 920 or 1020). At procedure 1410, the base station transmits, to a UE, a signal to activate a model monitoring process for AI/ML-based CSI prediction with a current model. Optionally, at procedure 1420, the base station transmits, to the UE, configuration information for configuring CSI-RS symbols for monitoring. The UE is configured to perform the AI/ML-based CSI prediction, and to implement an adjustment to the current model in response to determining that the adjustment is required. In certain configurations, calculation of performance metrics of the current model and monitoring of the current model may be subsequently performed at the UE or at the base station.

In certain embodiments, in a NW-side model monitoring process, the base station performs calculation of performance metrics of the current model. The base station monitors the current model for determining whether the adjustment to the current model is required. In response to determining that the adjustment to the current model is required, the base station transmits, to the UE, a signal indicating the adjustment to the current model. In one embodiment, the base station receives, from the UE, UE-specific assistance information including TDCP for assisting the base station in determining whether the adjustment to the current model is required. In another embodiment, the base station receives, from the UE, observed CSI-RS and predicted CSI-RS.

In certain embodiments, in a NW-side model monitoring process, the base station transmits, to the UE, UE-specific assistance information for assisting the UE in determining whether the adjustment to the current model is required. The base station receives, from the UE, determination feedback of the adjustment to the current model to the base station.

In certain embodiments, the base station receives, from the UE, performance metrics of the current model calculated by the UE. The base station monitors the current model for determining whether the adjustment to the current model is required. In response to determining that the adjustment to the current model is required, the base station transmits, to the UE, a signal indicating the adjustment to the current model. In one embodiment, the base station receives, from the UE, UE-specific assistance information including TDCP for assisting the base station in determining whether the adjustment to the current model is required.

In certain embodiments, when a prediction interval is equal to an observation interval of the CSI-RS symbols, calculation of performance metrics of the current model is performed based on observed CSI-RS symbols and predicted CSI-RS symbols obtained in the AI/ML-based CSI prediction. On the other hand, when the prediction interval is not equal to the observation interval of the CSI-RS symbols, calculation of the performance metrics of the current model is performed based solely on the predicted CSI-RS symbols.

In certain embodiments, the adjustment to the current model is deactivation (i.e., deactivating the current model), switch (i.e., switching from the current model to a new model), fallback (i.e., performing fallback from the current model to a non-AI based model), or update (i.e., updating or fine-tuning the current model).

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a base station, a signal to activate a model monitoring process for artificial intelligence (AI)/machine learning (ML)-based channel state information (CSI) prediction with a current model;
performing the AI/ML-based CSI prediction; and
in response to determining that an adjustment to the current model is required, implementing the adjustment to the current model.

2. The method of claim 1, further comprising:
receiving, from the base station, configuration information for configuring CSI reference signal (CSI-RS) symbols for monitoring.

3. The method of claim 2, wherein:
when a prediction interval is equal to an observation interval of the CSI-RS symbols, calculation of performance metrics of the current model is performed based on observed CSI-RS symbols and predicted CSI-RS symbols obtained in the AI/ML-based CSI prediction; and
when the prediction interval is not equal to the observation interval of the CSI-RS symbols, calculation of the performance metrics of the current model is performed based solely on the predicted CSI-RS symbols.

4. The method of claim 1, further comprising:
receiving, from the base station, a signal indicating the adjustment to the current model,
wherein the base station is configured to perform calculation of performance metrics of the current model, and to monitor the current model for determining whether the adjustment to the current model is required.

5. The method of claim 4, further comprising:
transmitting, to the base station, UE-specific assistance information including time domain channel property (TDCP) for assisting the base station in determining whether the adjustment to the current model is required.

6. The method of claim 4, further comprising:
transmitting, to the base station, observed CSI reference signal (CSI-RS) and predicted CSI-RS,
wherein the base station is configured to perform calculation of the performance metrics of the current model based on the observed CSI-RS and the predicted CSI-RS.

7. The method of claim 1, further comprising:
performing calculation of performance metrics of the current model;
determining whether the adjustment to the current model is required; and
in response to determining that the adjustment to the current model is required, implementing the adjustment to the current model, and transmitting determination feedback of the adjustment to the current model to the base station.

8. The method of claim 7, further comprising:
receiving, from the base station, UE-specific assistance information for assisting the UE in determining whether the adjustment to the current model is required.

9. The method of claim 1, further comprising:
performing calculation of performance metrics of the current model;
transmitting, to the base station, the performance metrics of the current model, wherein the base station is configured to determine whether the adjustment to the current model is required; and
receiving, from the base station, a signal indicating the adjustment to the current model.

10. The method of claim 9, further comprising:
transmitting, to the base station, UE-specific assistance information including time domain channel property (TDCP) for assisting the base station in determining whether the adjustment to the current model is required.

11. The method of claim 1, wherein the adjustment to the current model is:
deactivating the current model,
switching from the current model to a new model,
performing fallback from the current model to a non-AI based model, or
updating or fine-tuning the current model.

12. A method of wireless communication of a base station, comprising:
transmitting, to a user equipment (UE), a signal to activate a model monitoring process for artificial intelligence (AI)/machine learning (ML)-based channel state information (CSI) prediction with a current model,
wherein the UE is configured to perform the AI/ML-based CSI prediction, and to implement an adjustment to the current model in response to determining that the adjustment is required.

13. The method of claim 12, further comprising:
transmitting, to the UE, configuration information for configuring CSI reference signal (CSI-RS) symbols for monitoring.

14. The method of claim 13, wherein:
when a prediction interval is equal to an observation interval of the CSI-RS symbols, calculation of performance metrics of the current model is performed based on observed CSI-RS symbols and predicted CSI-RS symbols obtained in the AI/ML-based CSI prediction; and
when the prediction interval is not equal to the observation interval of the CSI-RS symbols, calculation of the performance metrics of the current model is performed based solely on the predicted CSI-RS symbols.

15. The method of claim 12, further comprising:
performing calculation of performance metrics of the current model;
monitoring the current model for determining whether the adjustment to the current model is required; and
in response to determining that the adjustment to the current model is required, transmitting, to the UE, a signal indicating the adjustment to the current model.

16. The method of claim 15, further comprising:
receiving, from the UE, UE-specific assistance information including time domain channel property (TDCP) for assisting the base station in determining whether the adjustment to the current model is required.

17. The method of claim 15, further comprising:
receiving, from the UE, observed CSI reference signal (CSI-RS) and predicted CSI-RS.

18. The method of claim 12, further comprising:
transmitting, to the UE, UE-specific assistance information including time domain channel property (TDCP) for assisting the UE in determining whether the adjustment to the current model is required; and
receiving, from the UE, determination feedback of the adjustment to the current model to the base station.

19. The method of claim 12, further comprising:
receiving, from the UE, performance metrics of the current model calculated by the UE;
monitoring the current model for determining whether the adjustment to the current model is required; and
in response to determining that the adjustment to the current model is required, transmitting, to the UE, a signal indicating the adjustment to the current model.

20. The method of claim 19, further comprising:
receiving, from the UE, UE-specific assistance information including time domain channel property (TDCP) for assisting the base station in determining whether the adjustment to the current model is required.
